(19) United States
(12) Patent Application Publication
(10) Pub. No.: US 2006/0230196 A1
(43) Pub. Date: Oct. 12, 2006

(54) Monitoring system and method using system management interrupt

(75) Inventors: Ying-Chih Lu, Taipei (TW); Meng-Hua Cheng, Taipei (TW); Chun-Yi Lee, Taipei (TW); Lung-Hung Yu, Taipei (TW); Chun-Lung Wu, Taipei (TW); Chia-Hsing Lee, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/096,325

(22) Filed: Mar. 30, 2005

(51) Int. Cl. G06F 3/00

(52) U.S. Cl. 710/48

(57) ABSTRACT

A monitoring system and method utilizing System Management Interrupt is proposed. The monitoring system is applicable to electronic facilities for monitoring and recording operational status of the electronic facilities. According to the operational status, the electronic facility generates System Management Interrupt (SMI) related data, and execute a specific program (a SMI Handler) stored in a first data storage area of the data storage unit that allows the SMI related data to be stored in a second data storage area of the data storage unit. Base on the stored SMI related data, a system software tester will be able to analyze abnormal situations occurred in the electronic facilities.

### FIELD OF THE INVENTION

The present invention relates to a monitoring system and method for System Management Interrupt application, and more particularly, to a System Management Interrupt signal for monitoring software and hardware operation status of electronic facilities and determining reasons causing failure when failure occurring in electronic facilities.

### DESCRIPTION OF THE PRIOR ART

During the development of electronic facilities, such as computers and servers etc, testers have to do testing under different operating systems. Through the testing processes, the testers may notice that the operation of an electronic facility suddenly hangs after a long time run. This abnormal situation is probably due to Dead Lock and/or Live Lock and/or poor system efficiency and/or slow system processing speed. In that situation, the testers have to determine whether it is a hardware failure, abnormal Basic Input/Output System (BIOS) operation or abnormal software operation etc. that causes the electronic facilities failure. Since the scope of these abnormal factors covering hardware, software and firmware, the cause cannot always be immediately determined and further removed by the testers. Supposing the abnormality occurs in an Internet server, the operation efficiency of the Internet system will be seriously affected.

According to the present design of electronic facilities, usually, when abnormality occurs in a certain component or during communication between certain components, (e.g. a Memory Single Bit Error, a Memory Multi-Bit error, a PCI/PCI-X/PCI-E/Parity or System Error of System Operation Cycle, a fan peculiarity SMI, a system over-temperature SMI, a CPU Internal error SMI, a CPU Machine Check SMI, a NMI (Non Mask Interrupt) leading to SMI, an IO Check error SMI etc.), SMI signals will sometimes be activated requesting the CPU to jump to a SMI Handler to execute a corresponding event.

From the above, testers can identify the abnormality occurred in the electronic facility by analyzing the SMI signals generated. However, data related to the SMI signals are not processed and analyzed by the electronic facilities afterwards, hence, SMI signals cannot be effectively monitored to determine the cause of abnormality. In light of the above drawbacks, how to analyze and detect abnormal operations using System Management Interrupt is therefore a critical problem to be solved.

### SUMMARY OF THE INVENTION

In order to solve the problems of the prior art, a primary objective of the present invention is to provide a monitoring system and method utilizing the System Management Interrupt application which generates and records SMI related data, allowing the testers to analyze and detect the reasons causing operational failures or abnormal situations of an electronic facility being monitored by looking at the SMI related data in order to promptly resolve the failure.

Another objective of the present invention is to provide a monitoring system and method utilizing the SMI so as to effectively monitor and record all SMI related data for analyzing the operational status of the electronic facility.

In order to achieve the above objectives, the present invention is to provide a monitoring system utilizing the System Management Interrupt (SMI) applicable to an electronic facility for monitoring and recording operational status of the electronic facility. The monitoring system comprises a SMI related data generator generating SMI related data according to the operational status of the electronic facilities; a data storage unit consisting of a first data storage area and a second data storage area, where a specific program (a SMI Handler) is stored in the first data storage area; and a CPU electrically coupled with the System Management Interrupt related data generator and the data storage unit for executing the specific program stored in the first data storage area in order to receive the SMI related data from the SMI related data generator, and to store the received SMI related data in the second data storage area.

A monitoring method using System Management Interrupt of the present invention is applicable to an electronic facility for monitoring and recording operational status of the electronic facility. The monitoring method comprises: generating SMI related data by a SMI related data generator according to the operational status; and causing a CPU to execute a specific program stored in a first data storage area of a data storage unit to store generated SMI related data into a second data storage area of the data storage unit.

In summary, the monitoring system and the method using the SMI of the present invention is achieved by executing a program such as a SMI Handler to obtain and store the SMI related data in a data storage, whereby the operational status of the electronic facilities can be monitored by a system software or the tester using these SMI related data.

### BRIEF DESCRIPTION OF THE DRAWINGS

A better understanding of the present invention can be obtained when the forgoing detailed description is considered in conjunction with the following drawings, in which:

FIG. 1 is a block diagram showing the basic structure of a monitoring system utilizing the System Management Interrupt of the present invention;

FIG. 2 is a diagram showing data storage contents in a second data storage area of a data storage unit of the monitoring system of the present invention; and

FIG. 3 is a flow chart showing a monitoring method utilizing the System Management Interrupt of the present invention.

### DETAILED DESCRIPTION OF THE PREFFERED EMBODIMENT

The descriptions below of specific embodiments are to illustrate the present invention. Others skilled in the art can easily understand other advantages and features of the present invention from contents disclosed in this specification. The present invention can also be carried out or applied to different embodiments. Every details of this specification can be modified based on different viewpoints and applications yet still within the scope of the present invention.

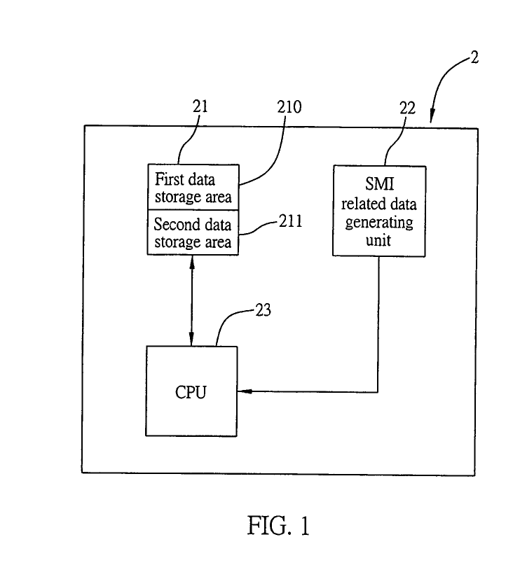

FIG. 1 illustrates a block diagram showing a monitoring system 2 applying the System Management Interrupt of the present invention. The monitoring system 2 is applicable to electronic facilities, such as computers and servers. The monitoring system 2 monitors and records the operational status of the electronic facility (e.g. hardware, BIOS and software operating status). The monitoring system 2 includes: a data storage unit 21, a SMI related data generating unit 22, and a Central Processing Unit (CPU) 23. There are other functional units existing in the monitoring system 2, but in order to simplify the diagram and the descriptions, only those components that related to the present invention is presented in FIG. 1. Other unrelated components, such as keyboards, monitors, data storage units like hard disks, Northbridge and Southbridge chipsets, etc, are not presented in the drawing.

After entering into the power-on mode, a Power-On Self Test (POST) of the electronic facility will be done by BIOS, the Operating System (OS) is entered in which the hardware and software operations are monitored by the monitoring system 2.

The data storage unit 21 of the monitoring system is, for instance, a memory that stores the BIOS. In this embodiment, the data storage unit 21 is used to store the operational data of the electronic facility. It is divided into a first data storage area 210 and a second data storage area 211. The first data storage area 210 stores a SMI specific Handler, and the second data storage area 211 is an Extended BIOS Data Area (EBDA) of the BIOS memory unit (e.g. EBDA with 4 K Byte capacity) for storing data related to SMI signals as a result of executing the specific Handler.

The SMI related data generating unit 22 can be, for example, a Southbridge chip or a Super Input/Output controller that generates the SMI signals. These SMI related data are for example, SMI signal paths, accumulated number of SMI signals, and starting and finishing time of the SMI signals. The SMI related data generating unit 22 is electrically coupled to circuitry and chipsets of the electronic facility that are likely to result in SMI, in order to detect the operational status of these units. SMI related data generated by the SMI related data generating unit 22 may be invoked by a hardware SMI or a software SMI and can be generated periodically (periodic SMI, e.g. generated every 5 seconds).

After the electronic facility enters the OS, the CPU 23 does not only execute general application software or programs that control, receive and process data being transmitted by electrically coupled input units and output units (peripheral devices), but also executes the SMI specific Handler so as to receive the SMI related data generated by SMI related data generating unit 22. The SMI related data are then stored in the second data storage area 211 of the data storage unit 21.

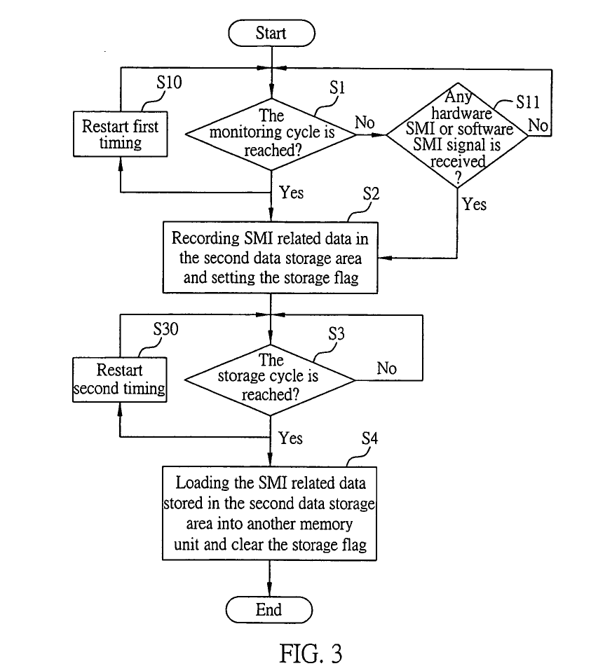

The SMI related data could be encoded before storing, so as to save space in the second data storage area 211 (The operation flow of the SMI specific Handler will be described in FIG. 3).

In one embodiment, the CPU 23 can periodically (e.g. every 10 minutes) store the SMI related data in the second data storage area 211 of the data storage unit 21 into another data storage unit (e.g. a built-in memory card or a hard disk etc.) before removing the data in the second data storage area 211 for future storage. This period can be predetermined by the tester. It should be noted that the SMI related data could be stored by executing software other than the SMI Handler described above.

In another embodiment, a monitoring cycle (e.g. 5 seconds) can be preset in order to generate periodic SMI signals for the CPU 23 to execute the SMI Handler every monitoring cycle so that any abnormality in important hardware or software unit can be determined for appropriate measures to be taken.

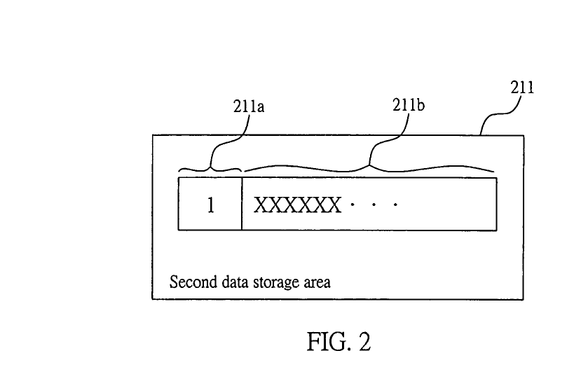

In addition, when the hardware SMI or the software SMI are generated, the CPU 23 will jump to execute the SMI Handler so as to receive and store the SMI related data from the SMI signals generating unit 22 in the second data storage area 211 of the data storage unit 21. In one embodiment, when storing the SMI related data, a storage flag is created for each SMI related data entry so that the CPU 23 can determine whether the SMI related data entry has been loaded into another data storage unit. As shown in FIG. 2, when the SMI related data 211b is not yet loaded into another data storage unit, the data storage flag 211a is set to be 1. Therefore, for every storage cycle, the electronic facility will load the SMI related data 211b that has a data storage flag 211a of 1 into another data storage unit, and then the data storage flag 211a is cleared. Values of the flag 211a of the present embodiment are adjustable to suit different needs.

The monitoring system of the SMI application of the present invention includes a Baseboard Management Controller (BMC) (not shown) electrically coupled with the CPU 23. Through the BMC, SMI related data (i.e. the data stored in the second data storage area 211 of the storage unit 21 or another storage unit) can be transmitted to a remote server via a network system (e.g. an Internet or intranet) for the server supervisors to remotely analyzing and be aware of the present operational status.

FIG. 3 illustrates a process flow of the monitoring method using SMI of the present invention. After the electronic facility enters into the OS, according to the testing requirements, the tester can selectively activate the monitoring method of the present invention, wherein the CPU 23 executes the SMI specific Handler so as to receive the SMI related data generated by the SMI related data generating unit 22. The SMI related data are then stored in the second data storage area 211 of the data storage unit 21.

As shown in FIG. 3, in step S1, a timing process is performed by the monitoring system 2 for generating a first timing. Since the timing process is conventional, thus the hardware or software configurations required by the timing process will not be further described. It is then determined whether the first timing equals to the predetermined monitoring cycle. If yes, move to both steps S2 and S10. In step S10, the monitoring system 2 restarts the first timing process and returns to the step S1. This allows the electronic facility to move to step S2 every monitoring cycle. Hence, step S1 allows periodic monitoring. If the predetermined monitoring cycle is not equal (smaller), move to step S11, in which it is determined whether any hardware SMI or software SMI has been received. If so, then move to step S2 from step S11. If not, then return to step S1.

In step S2 (this step is executed in the SMI Handler), the SMI related data is stored in the second data storage area 211 of the data storage unit 21. When storing the SMI related data, the data storage flag is also created for the CPU 23 to identify whether this SMI related data entry has been loaded into another data storage unit, then move to step S3.

In step S3, the monitoring system 2 performs a second timing process for generating a second timing, and determines whether the second timing equals to the preset storage cycle in the SMI specific Handler. If so, move to both step S4 and S30. In step S30, the monitoring system 2 restarts the second timing process and returns to the step S3, i.e. to allow the electronic facility to move to step S4 every storage cycle. If the second timing does not equal to (i.e. smaller than) the preset storage cycle in the SMI specific Handler, then continue timing in step S3.

In step S4 (the step can be executed in a software under the OS or the SMI Handler), electronic facility store the SMI related data in the second data storage area 211 of the data storage unit 32 into another data storage unit, and clear (or alter) the flags corresponding to the loaded SMI related data in the second data storage area 211.

Therefore, the monitoring system and the method using SMI of the present invention is achieved by executing the SMI Handler via the CPU to obtain the SMI related data, and to store the SMI related data in the second data storage area 211 of the data storage unit 21, whereby testers can monitor the system operation status according to the SMI related data stored in the second data storage 211. Furthermore, the SMI related data can be loaded into another data storage unit. Additionally, the SMI related data can be sent to the remote server by the BMC for remote control.

The embodiments described above are only to illustrate aspects of the present invention; it should not be construed as to limit the scope of the present invention in any way. While the invention has been described in detail with reference to specific embodiments thereof, it will be apparent in the art that various changes and modifications can be made, and equivalents employed, without departing from the scope of the claims.

What is claimed is:

1. A monitoring system using System Management Interrupt (SMI) applicable to an electronic facility for monitoring and recording operational status of the electronic facility, the monitoring system comprising:
a SMI related data generator generating SMI related data according to the operational status of the electronic facility;
a data storage unit consisting of a first data storage area and a second data storage area, wherein a specific program is stored in the first data storage area; and
a CPU being electrically coupled with the System Management Interrupt related data generator and the data storage unit for executing the specific program stored in the first data storage area in order to receive the SMI related data from the SMI related data generator, and to store the received SMI related data in the second data storage area.

2. The system as claimed in claim 1, wherein steps performed by executing the specific program comprises:
causing the CPU to store the SMI related data received every monitoring cycle into the second data storage area of the data storage unit, and creating a corresponding storage flag when storing the SMI related data; and
causing the CPU to load the SMI related data stored in the second data storage area of the data storage unit into another data storage unit every storage cycle, and change the corresponding storage flag of the loaded SMI related data in the second data storage area.

3. The system as claimed in claim 2, wherein the steps performed by executing the specific program further comprises:
encoding the SMI related data received by the CPU before storing them in the second data storage area of the data storage unit.

4. The system as claimed in claim 1, wherein the SMI related data generator is one of a south bridge chip and a Super I/O controller.

5. The system as claimed in claim 1, wherein the data storage unit is used for storing memory units of a Basic Input/Output System (BIOS).

6. The system as claimed in claim 5, wherein the second data storage area is an Extended BIOS Data Area (EBDA).

7. The system as claimed in claim 1, wherein the SMI related data is at least one selected from the group consisting of SMI paths, an accumulated number of SMI occurrence and SMI starting and ending time.

8. A monitoring method using System Management Interrupt applicable to an electronic facility for monitoring and recording operational status of the electronic facility, the monitoring method comprising:
generating SMI related data according to the operational status; and
causing a CPU to execute a specific program stored in a first data storage area of a data storage unit to store generated SMI related data into a second data storage area of the data storage unit.

9. The method as claimed in claim 8, wherein the steps executed by the specific program comprises:
causing the CPU to store the SMI related data received every monitoring cycle into the second data storage area of the data storage unit, and creating corresponding storage flag when storing the SMI related data; and
causing the CPU to load the SMI related data stored in the second data storage area of the data storage unit into another data storage unit every storage cycle, and change the corresponding storage flag of the loaded SMI related data in the second data storage area.

10. The method as claimed in claim 9, wherein the steps performed by executing the specific program further comprises:
encoding the SMI related data received by the CPU before storing them in the second data storage area of the data storage unit.

11. The method as claimed in claim 9, wherein the CPU further determines whether the received SMI related data is related to one of a hardware SMI and a software SMI.

12. The method as claimed in claim 8, wherein the SMI related data is generated by one of a south bridge chip and a Super I/O controller.

13. The method as claimed in claim 8, wherein the data storage unit is for storing memory units of a Basic Input/Output System (BIOS).

14. The method as claimed in claim 13, wherein the second data storage area is the Extended DIOS Data Area (EBDA).

15. The method as claimed in claim 8, wherein the SMI related data is one selected from the group consisting of SMI paths, an accumulated number of SMI occurrence and SMI starting and ending time.
